(19) United States
(12) Patent Application Publication
(10) Pub. No.: US 2016/0073062 A1
(43) Pub. Date: Mar. 10, 2016

(54) APPROACHING OBJECT DETECTION APPARATUS FOR A VEHICLE AND APPROACHING OBJECT DETECTION METHOD FOR THE SAME

(71) Applicant: TOYOTA JIDOSHA KABUSHIKI KAISHA, Toyota-shi (JP)

(72) Inventor: Masamichi OHSUGI, Suntou-gun (JP)

(73) Assignee: TOYOTA JIDOSHA KABUSHIKI KAISHA, Toyota-shi (JP)

(21) Appl. No.: 14/823,459

(22) Filed: Aug. 11, 2015

(30) Foreign Application Priority Data
Sep. 5, 2014 (JP) 2014-181602

(51) Int. Cl. H04N 7/18; G06T 7/00; G06K 9/00

(52) U.S. Cl. CPC H04N 7/183; G06K 9/00791; G06T 7/0042; G06T 2207/30241; G06T 2207/30256

(57) ABSTRACT

Provided is an approaching object detection apparatus for a vehicle, which is configured to identify an object approaching the vehicle using optical flow vectors calculated based on two images. The apparatus can avoid a non-detection in which an approaching object is determined as a non-approaching object and an erroneous detection in which a non-approaching object is determined as an approaching object, which are caused by the change of horizontal components of the optical flow vectors when the vehicle changes its direction. An approaching object is identified based on a corrected vector obtained by correcting each optical flow vector with a turning correction vector, the turning correction vector being calculated based on a mean of the horizontal components of a pair of vectors among the optical flow vectors, the pair of vectors having starting points that are line-symmetric to each other with respect to a perpendicular line (virtual center line) passing through a focus of expansion.

### BACKGROUND OF THE INVENTION

1. Field of the Invention

The present invention relates to an approaching object detection apparatus for a vehicle and an approaching object detection method for a vehicle, which are configured to detect an object approaching the vehicle based on an image photographed by an image pickup apparatus (camera) fixed to the vehicle.

2. Description of the Related Art

In Japanese Patent No. 4259368, there is disclosed a nose-view monitoring apparatus (hereinafter also referred to as “related-art apparatus”) for detecting an object approaching a vehicle through use of an optical flow vector that is calculated based on an image photographed by an image pickup apparatus arranged on a front end of the vehicle. The optical flow vector (hereinafter also simply referred to as “flow vector”) is a vector representing a displacement of a photographic subject or a part of photographic subject (hereinafter referred to as “subject”) included in both of two images that are photographed at a predetermined time interval by the same image pickup apparatus, the displacement being measured in those two images.

The related-art apparatus determines a subject as an approaching object when the flow vector based on the subject included in an image (left side image) that is photographed for a left side region outside the vehicle has a rightward horizontal component. Similarly, the related-art apparatus determines a subject as an approaching object when the flow vector based on the subject included in an image (right side image) that is photographed for a right side region outside the vehicle has a leftward horizontal component.

More specifically, a point (namely, focus of expansion) indicating a straight ahead direction of the vehicle in an image photographed by a nose-view camera included in the related-art apparatus is located ahead of the travel direction of the vehicle in the image. Accordingly, when the vehicle is stopped, the flow vector based on a subject that is moving and eventually crosses the front of the travel direction of the vehicle has a horizontal component that is directed across a perpendicular line (virtual center line) passing through the focus of expansion in the image.

For example, the flow vector based on a subject that is located on the left side of the vehicle and is moving in a direction of eventually crossing the virtual center line in the image from left to right has a rightward horizontal component. Then, the related-art apparatus identifies the subject corresponding to the flow vector having the rightward horizontal component in the left side image as an approaching object. Similarly, the related-art apparatus identifies the subject corresponding to the flow vector having a leftward horizontal component in the right side image as an approaching object.

However, when the direction of the vehicle is changed, namely, when the vehicle travels with its steering wheels turned left or right, the determination of the approaching object may not correctly be carried out. For example, when the vehicle is turning right, namely, when the direction of the vehicle is being changed as a result of the vehicle traveling forward with its steering wheels turned right, the horizontal component of each flow vector becomes larger in the leftward direction compared to the case in which the vehicle is not turning.

As a result, the “rightward horizontal component of the flow vector based on the approaching object included in the left side image” becomes smaller due to the right turning of the vehicle, and in some cases, the flow vector has a leftward horizontal component. In this case, there is a concern of occurrence of a “non-detection” in which the related-art apparatus may not determine an actually approaching subject as an approaching object.

On the other hand, there is a possibility that the flow vector based on a subject included in a right side image does not originally have a leftward component, but the right turning of the vehicle causes the flow vector to have a leftward horizontal component. In this case, there is a concern of occurrence of an “erroneous detection” in which the related-art apparatus determines a subject as an approaching object although this is not true.

In order to address this issue, the related-art apparatus suspends the processing of detecting an approaching object when at least one of the non-detection or the erroneous detection is likely to occur due to the turning of the vehicle, and thus there is a concern that the function of detecting an approaching object cannot be achieved with accuracy expected by a driver of the vehicle. Specifically, the related-art apparatus suspends the processing of detecting an approaching object when the magnitude of the steering angle of the vehicle, which is correlated with the turning speed (rotational speed in horizontal direction) of the vehicle, exceeds a predetermined value.

In the related-art apparatus, for example, when the vehicle enters a T-junction in order to turn left or right and is stopped to confirm whether or not there is another vehicle approaching from the left side or the right side with its steering wheel being turned, namely, with its steering angle exceeding the predetermined value, the processing of detecting an approaching object is suspended. As a result, there are some cases in which the function of detecting an approaching object included in the related-art apparatus cannot be used when the vehicle enters the T-junction, which is one of situations in which detection of an object (for example, another vehicle) approaching from the side is most beneficial.

### SUMMARY OF THE INVENTION

The present invention has been made in order to solve this problem, and has an object to provide an approaching object detection apparatus for a vehicle, which is capable of detecting an approaching object even when the vehicle is stopped with its steering wheel being turned or when the vehicle is traveling with its steering wheel being turned (namely, turning).

In order to achieve the above-mentioned object, according to one embodiment of the present invention, there is provided an approaching object detection apparatus for a vehicle (hereinafter also referred to as “apparatus of the present invention”), including an image pickup apparatus fixed to a vehicle body of the vehicle, for picking up an image including a left side region and a right side region outside the vehicle body, a vector acquisition unit, a correction vector calculation unit, a correction unit, and an approaching object identification unit.

The vector acquisition unit acquires, based on a first image acquired by the image pickup apparatus at a first time point and a second image acquired by the image pickup apparatus at a second time point after a predetermined time period from the first time point, a plurality of optical flow vectors, each representing a starting point at the first time point, a displacement amount from the first time point to the second time point, and a displacement direction from the first time point to the second time point for an arbitrary subject photographed in both of the first image and the second image.

The correction vector calculation unit calculates, as a turning correction vector, a vector that is based on a mean of horizontal components of a pair of vectors among the plurality of optical flow vectors, the pair of vectors having starting points that are line-symmetric to each other with respect to a “virtual center line, the virtual center line passing through a point indicating a straight ahead direction of the vehicle in an image plane including the left side region and the right side region, the virtual center line being orthogonal to a lateral horizontal direction of the vehicle body”.

The image plane is a plane onto which an arbitrary subject (three-dimensional object) photographed by the image pickup apparatus is projected. For example, the image pickup apparatus may not be a single image pickup apparatus, but rather may be constructed of a “first image pickup apparatus serving to photograph the left side region” and a “second image pickup apparatus serving to photograph the right side region”. In this case, the image plane is a plane including a “plane (first plane) onto which a subject photographed by the first image pickup apparatus is projected” and a “plane (second plane) onto which a subject photographed by the second image pickup apparatus is projected”.

The point indicating the straight ahead direction of the vehicle in the image plane is also a point intersected by respective lines passing through starting points and ending points of respective flow vectors acquired based on stationary subjects (for example, construction) when the vehicle is traveling forward (traveling straight ahead) (refer to FIG. 3). In other words, the point indicating the straight ahead direction of the vehicle can be considered as the focus of expansion in the image plane.

Therefore, the correction vector calculation unit can be described in the following way.

That is, the correction vector calculation unit calculates, as a turning correction vector, a vector that is based on a mean of horizontal components of a pair of vectors among the plurality of optical flow vectors, the pair of vectors having starting points that are line-symmetric to each other with respect to a “virtual center line, the virtual center line passing through a focus of expansion in an image plane including the left side region and the right side region, the virtual center line being orthogonal to a lateral horizontal direction of the vehicle body”.

The correction unit carries out a vector correction by correcting each of the plurality of optical flow vectors based on the turning correction vector, to thereby acquire a plurality of corrected vectors.

The approaching object identification unit identifies an object approaching the vehicle based on the plurality of corrected vectors.

The apparatus of the present invention carries out a vector correction for a plurality of flow vectors (for example, each arrow in FIG. 4B) acquired based on images at the time of turning of the vehicle and estimates “flow vectors (for example, each arrow in FIG. 4A) that could have been acquired if the vehicle had traveled straight ahead without changing its direction”. In other words, the apparatus of the present invention acquires corrected vectors (vectors with influence of turning eliminated) based on the flow vectors (vectors having possibility of being influenced by turning) acquired by the vector acquisition unit.

More specifically, each flow vector can be considered as a sum of:
(a) an own vehicle movement vector caused by movement of the vehicle;
(b) an own vehicle rotation vector caused by change of direction of the vehicle; and
(c) a subject movement vector caused by movement of the subject.

When a distance between the vehicle and each of the subjects is constant, as illustrated in FIG. 5A, the horizontal component of the own vehicle movement vector contained in one of the pair of vectors and the horizontal component of the own vehicle movement vector contained in the other of the pair of vectors have opposite directions and the same magnitude. In other words, in this case, a mean of the horizontal components of the own vehicle movement vectors contained respectively in the pair of vectors is a zero vector. In other words, the horizontal components of the own vehicle movement vectors are cancelled out through the calculation of the mean of the pair of vectors.

On the other hand, as illustrated in FIG. 5B, respective horizontal components of the own vehicle rotation vectors have the same direction and the same magnitude irrespective of positions of the starting points of the flow vectors. In other words, the mean of the horizontal components of the own vehicle rotation vectors contained respectively in the pair of vectors equals the horizontal components of the own vehicle rotation vectors respectively contained in the original pair of vectors.

Meanwhile, when each subject does not move, the horizontal component of an actually acquired flow vector is a “sum (synthesis) of the horizontal component of the own vehicle movement vector and the horizontal component of the own vehicle rotation vector” as illustrated in FIG. 5C.

With that in mind, the apparatus of the present invention acquires the turning correction vector based on the mean of the horizontal components of a pair of flow vectors. Further, the apparatus of the present invention estimates the flow vector that could have been acquired if the vehicle had traveled straight ahead by carrying out the vector correction based on the turning correction vector.

As a result, the apparatus of the present invention can identify an approaching object after eliminating the “change of the horizontal components of flow vectors caused by turning” even when the vehicle is turning. In addition, a sensor for detecting a steering angle of the vehicle is unnecessary for the implementation of the apparatus of the present invention, and hence costs for identifying an approaching object at the time of turning can be prevented from rising.

In addition, according to one embodiment of the present invention, preferably, the correction vector calculation unit calculates, as the turning correction vector, a vector equivalent to a change of a horizontal component of the each of the plurality of optical flow vectors caused by a change of direction of the vehicle from the first time point to the second time point; and the correction unit carries out the vector correction by subtracting the turning correction vector from the each of the plurality of optical flow vectors.

With this, by carrying out the vector correction, the apparatus of the present invention can reliably eliminate the change of the horizontal components of respective flow vectors caused by the change of direction of the vehicle, namely, (the horizontal components of) the own vehicle rotation vectors contained respectively in the horizontal components of the respective flow vectors.

In addition, according to another embodiment of the present invention, preferably, the correction vector calculation unit acquires, for a plurality of the pair of vectors, a plurality of mean vectors, each being the mean of the horizontal components of each of the plurality of the pair of vectors, and adopts a vector having a highest frequency as the turning correction vector.

As described above, the apparatus of the present invention acquires the turning correction vector based on the mean of the horizontal components of a pair of vectors. However, in some cases, at least one of subjects (subject on left side of travel direction of vehicle and subject on right side of travel direction of vehicle) corresponding respectively to a pair of vectors may be moving. In this case, at least one of the pair of vectors contains a subject movement vector. Accordingly, even when the mean of the horizontal components of the own vehicle movement vectors contained respectively in the pair of vectors is the zero vector, the mean of the horizontal components of the pair of vectors differs from the horizontal components of the own vehicle rotation vectors due to the influence of the subject movement vector.

In addition, as described above, when the distance between the vehicle and each of the subjects is constant, the mean of the horizontal components of the own vehicle movement vectors contained respectively in the pair of vectors is the zero vector, but in actuality, the distance between the vehicle and each of the subjects is not constant and has a variation in many cases. Further, the own vehicle movement vector becomes larger as the distance between the vehicle and the subject becomes shorter. Therefore, when distances between the vehicle and the subjects corresponding respectively to the pair of vectors (subject on left side of travel direction of vehicle and subject on right side of travel direction of vehicle) are not equal to each other, the mean of the horizontal components of the own vehicle movement vectors is not the zero vector. Accordingly, in this case, the mean of the horizontal components of the pair of vectors differs from the horizontal components of the own vehicle rotation vectors due to the influence of the variation in distance between the vehicle and each of the subjects.

However, for example, when the vehicle enters the T-junction as illustrated in FIG. 2, in many cases, the subjects (subject on left side of travel direction of vehicle and subject on right side of travel direction of vehicle) corresponding respectively to a pair of vectors are constructions such as road surfaces, buildings, walls, and the like. Accordingly, the distances between the vehicle and the subjects corresponding respectively to the pair of vectors are likely to be approximately equal to each other. Therefore, the mean of the horizontal components of the own vehicle movement vectors contained respectively in the pair of vectors is the zero vector in relatively many cases.

In addition, subjects in the image can be classified into stationary objects (for example, construction) and moving objects (for example, other traveling vehicles). Generally, an area occupied by moving objects in the image is smaller than an area occupied by stationary objects in the image. Therefore, a large proportion of mean vectors calculated based on respective flow vectors in the image does not contain the mean of the horizontal components of the subject movement vectors. In other words, a large proportion of mean vectors contains only the mean of the horizontal components of the own vehicle rotation vectors.

As described above, a mean vector having the highest frequency among a plurality of acquired mean vectors is not influenced by the subject movement vector and the variation in distance between the vehicle and each of the subjects, and hence the mean vector is likely to equal the horizontal components of the own vehicle rotation vectors. In other words, according to this embodiment, it is possible to acquire highly precisely the turning correction vector, which is a vector equivalent to the horizontal components of the own vehicle rotation vectors.

Note that, the present invention also relates to a vehicle on which the approaching object detection apparatus for a vehicle is mounted, and also relates to a method that is used in the approaching object detection apparatus for a vehicle.

### BRIEF DESCRIPTION OF THE DRAWINGS

FIG. 1 is a schematic diagram of a vehicle to which an approaching object detection apparatus for a vehicle (hereinafter also referred to as “this detection apparatus”) is applied according to an embodiment of the present invention (hereinafter also referred to as “this vehicle”).

FIG. 2 is a diagram for illustrating a subject approaching the vehicle and a subject moving away from the vehicle when the vehicle enters a T-junction.

FIG. 3 is an example of an image and an optical flow vector that are acquired by the detection apparatus.

FIG. 4A and FIG. 4B are a set of examples of a left side image and a right side image that are displayed on a display device included in the detection apparatus.

FIG. 5A to FIG. 5C are diagrams for illustrating a horizontal component of an own vehicle movement vector and a horizontal component of an own vector rotation vector.

FIG. 6 is a flowchart for illustrating a processing routine of detecting an approaching object, which is executed by a CPU of the detection apparatus.

FIG. 7 is a diagram for illustrating a pair of flow vectors.

FIG. 8 is a histogram for showing a distribution of mean vectors.

### DETAILED DESCRIPTION OF THE PREFERRED EMBODIMENTS

(Configuration)

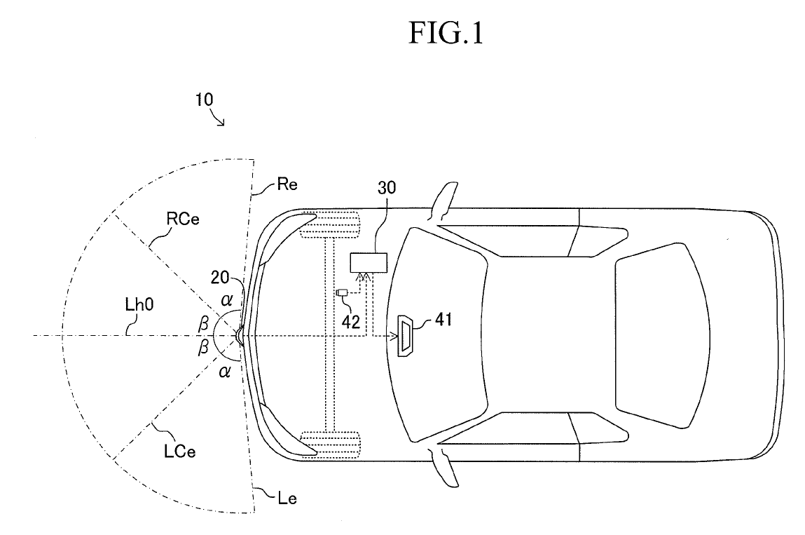

Now, a description is given of an approaching object detection apparatus for a vehicle according to an embodiment of the present invention (hereinafter also referred to as “this detection apparatus”) with reference to the drawings. This detection apparatus is applied to a vehicle 10 whose schematic configuration is illustrated in FIG. 1. This detection apparatus includes a camera 20 and an ECU 30.

The camera 20 is fixed to a central portion of a front end of a vehicle body of the vehicle 10. An angle of view (field of view) in the horizontal direction of the camera 20 includes the front of a travel direction of the vehicle 10, and is approximately 180 degrees from a vicinity in the left horizontal direction to a vicinity in the right horizontal direction. Specifically, the angle of view in the horizontal direction of the camera 20 equals an angle (2α+2β) between a straight line Le and a straight line Re illustrated in FIG. 1. A plane onto which each of subjects photographed by the camera 20 is projected is also referred to as an “image plane”. The camera 20 outputs signals representing photographed images to the ECU 30.

The ECU 30 is an electronic circuit including a known microcomputer and includes, for example, a CPU, a ROM, a RAM, and an interface. The ROM stores programs to be executed by the CPU.

The ECU 30 is connected to a display device 41 and a vehicle speed sensor 42. The display device 41 is arranged on a center console (not shown) provided in a vehicle interior of the vehicle 10. When processing of detecting an approaching object described later is carried out, the display device 41 continuously displays an image (left side image) photographed for a left side region outside the vehicle 10 and an image (right side image) photographed for a right side region outside the vehicle 10 side by side with each other, which are parts of the image photographed by the camera 20. In other words, the display device 41 displays a moving picture representing the left side region and the right side region outside the vehicle 10.

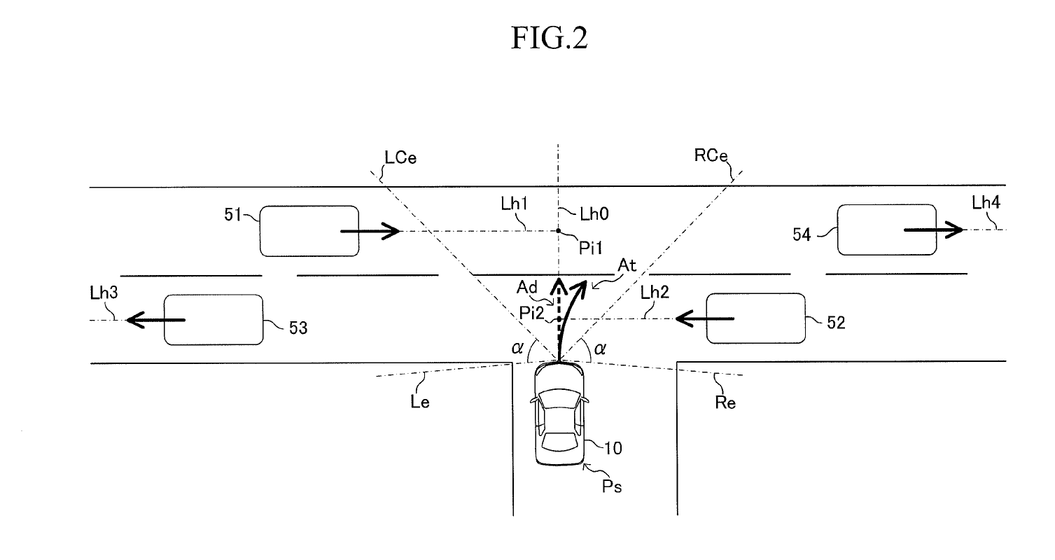

As illustrated in FIG. 2, each of the angles of view α of the left side image and the right side image is a range that is difficult for a driver of the vehicle 10 to visually recognize when the vehicle 10 enters a T-junction having a poor lateral visibility. The angle of view in the horizontal direction of the left side image is a part of the angle of view of the camera 20, and is the angle between the straight line Le and a straight line LCe. The angle of view in the horizontal direction of the right side image is a part of the angle of view of the camera 20, and is the angle between a straight line RCe and the straight line Re.

As described above, both of the angle of view in the horizontal direction of the left side image and the angle of view in the horizontal direction of the right side image are each the angle α, and are equal to each other. In addition, as illustrated in FIG. 1, both of the angle between a “line (half line) Lh0 extending from the camera 20 toward the front of the travel direction of the vehicle 10” and the line LCe and the angle between the straight line Lh0 and the straight line RCe are each the angle β, and are equal to each other. Therefore, the angle of view in the horizontal direction of the left side image and the angle of view in the horizontal direction of the right side image are laterally symmetric to each other with respect to the straight line Lh0.

The display device 41 includes an operation switch (not shown). The driver of the vehicle 10 can operate this operation switch to select any one of an on-state and an off-state of the processing of detecting an approaching object. In addition, the display device 41 includes a speaker (not shown).

The vehicle speed sensor 42 detects a rotational speed of an axle of the vehicle 10 and outputs a signal representing a traveling speed (vehicle speed) Vs of the vehicle 10.

(Outline of Processing of Detecting an Approaching Object)

The camera 20 photographs an image at a predetermined photographing cycle (predetermined time period) Δt. The ECU 30 acquires a flow vector based on an image (first image) photographed by the camera 20 and an image (second image) photographed after the photographing cycle Δt by the camera 20. In other words, the second image is the latest image photographed by the camera 20, and the first image is the image that is photographed by the camera 20 before the second image by the photographing cycle Δt. For convenience, the time point when the first image is photographed is also referred to as a “first time point”. For convenience, the time point when the second image is photographed is also referred to as a “second time point”.

The ECU 30 acquires, for each of a plurality of subjects, the flow vector, which is a vector representing a starting point of an arbitrary subject at the first time point photographed in both of the first image and the second image and representing a displacement amount and displacement direction from the first time point to the second time point for that subject. In other words, the ECU 30 acquires a plurality of flow vectors.

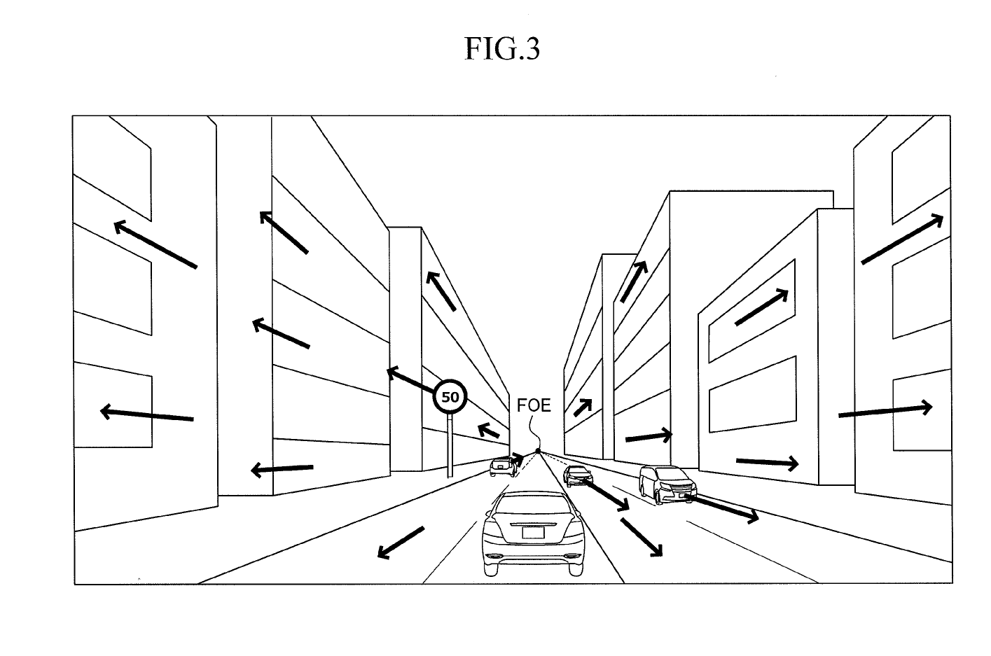

Examples of the flow vector are represented by the respective black arrows in FIG. 3. In FIG. 3, for convenience, there is illustrated an image including the front of the travel direction of the vehicle 10 photographed by the camera 20 instead of the left side image and the right side image that are displayed on the display device 41. In the example of FIG. 3, the vehicle 10 is traveling forward (traveling straight ahead) from the first time point to the second time point. The image illustrated in FIG. 3 is the first image. Each flow vector is acquired based on this first image and the second image (photographed after first image). Note that, in FIG. 3, an intersection between respective lines passing through starting points and ending points of respective flow vectors based on stationary subjects (for example, construction) is also referred to as a “focus of expansion FOE”. The focus of expansion FOE can also be considered as a point indicating a straight ahead direction of the vehicle 10 in the image illustrated in FIG. 3.

Each of flow vectors illustrated in FIG. 3 can also be considered as a sum of a vector representing a displacement of a subject in the image plane caused by movement of the subject and a vector representing a displacement of the subject in the image plane caused by the vehicle 10 traveling forward. For convenience, the former vector is also referred to as a “subject movement vector” and the latter vector is also referred to as an “own vehicle movement vector”.

Further, when the direction of the vehicle 10 is being changed by the vehicle 10 traveling with its steering wheels turned left or right (namely, turning), namely, when the vehicle is rotating in the horizontal direction, each flow vector is changed by the rotation. For convenience, a vector obtained by taking a difference between the flow vector in the case in which the vehicle 10 is rotating and the flow vector in the case in which the vehicle 10 is not rotating is also referred to as an “own vehicle rotation vector”. In other words, each flow vector can be considered as a sum of the subject movement vector, the own vehicle movement vector, and the own vehicle rotation vector.

As described later, the ECU 30 needs to take an influence of the own vehicle rotation vector into account when the processing of detecting an approaching object is carried out at the time of the change of direction of the vehicle 10. For that reason, a description is given of an operation of the ECU 30 at the time of execution of the processing of detecting an approaching object by taking the case of FIG. 2 in which the vehicle 10 enters a T-junction as an example.

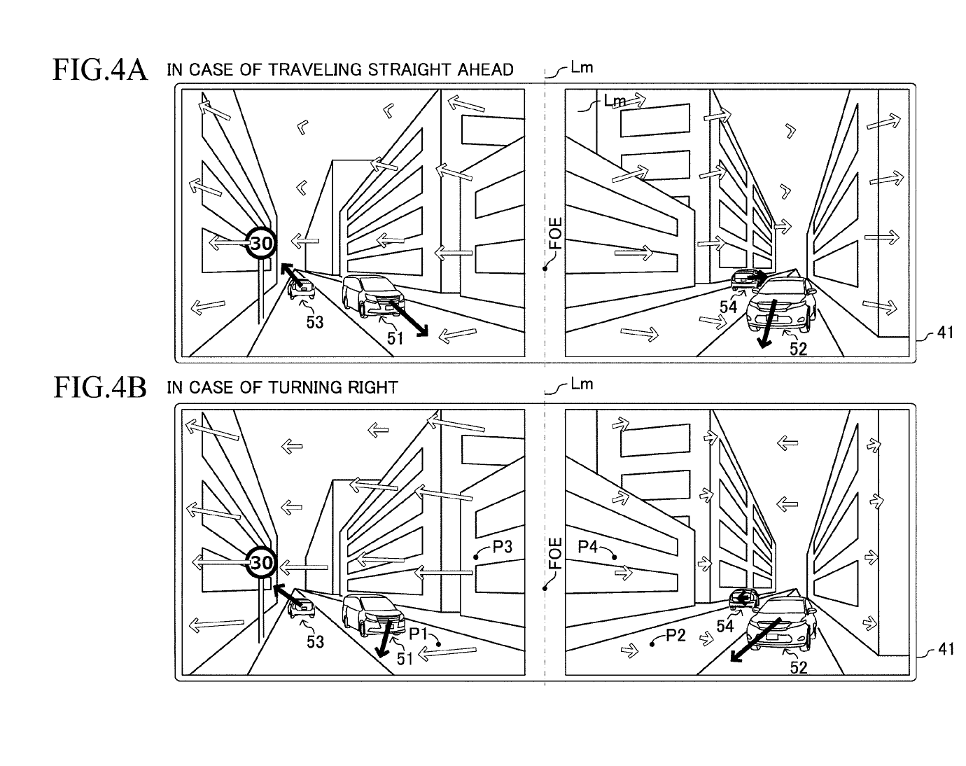

FIG. 4A and FIG. 4B are each an example of the left side image and the right side image that are displayed on the display device 41. The images illustrated in FIG. 4A and FIG. 4B are each the first image as in the case of the example of FIG. 3, and those images are photographed when the vehicle 10 is at a position Ps in FIG. 2. Each of flow vectors illustrated in FIG. 4A and FIG. 4B is acquired based on this first image and the second image (photographed after first image). In FIG. 4A, there is illustrated an example of the flow vectors in the case in which the vehicle 10 is traveling straight ahead (without changing its direction) as indicated by the dashed arrow Ad in FIG. 2. On the other hand, in FIG. 4B, there is illustrated an example of the flow vectors in the case in which the vehicle 10 is entering the T-junction while changing its direction to the right (namely, turning right) as indicated by the solid arrow At in FIG. 2.

The black arrows illustrated in FIG. 4A and FIG. 4B each represent flow vectors based on vehicles other than the vehicle 10. On the other hand, the hollow arrows illustrated in FIG. 4A and FIG. 4B represent flow vectors based on subjects that do not move, such as constructions or road signs.

In the case of FIG. 4A, namely, in the case in which the vehicle 10 is traveling straight ahead, the ECU 30 can identify, as an approaching object, a “subject that is appearing in the left side image and whose corresponding flow vector has a rightward horizontal component”. Similarly, the ECU 30 can identify, as an approaching object, a “subject that is appearing in the right side image and whose corresponding flow vector has a leftward horizontal component”.

Now, a specific description is given of this point with reference to FIG. 2 and FIG. 4A and FIG. 4B. When the half line Lh0 and a half line extending from the moving subject toward the front of the travel direction of the subject intersect, the flow vector based on the subject has a horizontal component that is directed across a perpendicular line Lm passing through the focus of expansion FOE in the image. The perpendicular line Lm passing through the focus of expansion FOE, namely, the perpendicular line passing through the point indicating the straight ahead direction of the vehicle 10, is also referred to as a “virtual center line Lm”. The virtual center line Lm can also be defined as a line passing through the focus of expansion FOE in the image plane and orthogonal to the lateral horizontal direction of the vehicle body of the vehicle 10.

For example, the half line Lh0 and a half line Lh1, which extends from a subject 51 as a vehicle approaching the vehicle 10 from the left side toward the front of the travel direction of the subject 51, intersect at a point Pi1. In other words, when the vehicle 10 is stopped, the subject 51 eventually crosses the front of the travel direction of the vehicle 10 from left to right. Hence, the flow vector based on the subject 51 in the left side image of FIG. 4A has a rightward horizontal component. Accordingly, the ECU 30 can identify the subject 51 as an approaching object.

Similarly, in FIG. 2, the half line Lh0 and a half line Lh2, which extends from a subject 52 as a vehicle approaching the vehicle 10 from the right side toward the front of the travel direction of the subject 52, intersect at a point Pi2. Hence, the flow vector based on the subject 52 in the right side image of FIG. 4A has a leftward horizontal component. Accordingly, the ECU 30 can identify the subject 52 as an approaching object.

On the other hand, in FIG. 2, the half line Lh0 and a half line Lh3, which extends from a subject 53 as a vehicle moving away from the vehicle 10 on the left side of the vehicle 10 toward the front of the travel direction of the subject 53, do not intersect. Hence, the flow vector based on the subject 53 in the left side image of FIG. 4A does not have a rightward horizontal component. Accordingly, the ECU 30 can identify the subject 53 as a non-approaching object.

Similarly, in FIG. 2, the half line Lh0 and a half line Lh4, which extends from a subject 54 as a vehicle moving away from the vehicle 10 on the right side of the vehicle 10 toward the front of the travel direction of the subject 54, do not intersect. Hence, the flow vector based on the subject 54 in the right side image of FIG. 4A does not have a leftward horizontal component. Accordingly, the ECU 30 can identify the subject 54 as a non-approaching object.

On the other hand, in the case of FIG. 4B, namely, in the case in which the vehicle 10 is turning right, each of the flow vectors illustrated in FIG. 4B has a larger leftward horizontal component compared to each of the flow vectors illustrated in FIG. 4A because of the influence of the own vehicle rotation vector.

As a result, the flow vector based on the subject 51 in FIG. 4B has a leftward horizontal component. Therefore, a “non-detection” may occur in which the ECU 30 identifies the approaching subject 51 as a non-approaching object.

In addition, the flow vector based on the subject 54 in FIG. 4B has a leftward horizontal component. Therefore, an “erroneous detection” may occur in which the ECU 30 identifies the subject 54 moving away as an approaching object.

In order to address this issue, the ECU 30 carries out a vector correction for each of the flow vectors to eliminate the influence of the change of direction of the vehicle 10 at the time when the process of detecting an approaching object is carried out. More specifically, the ECU 30 estimates a vector equivalent to the horizontal component of the own vehicle rotation vector as a “turning correction vector”. The horizontal component of the “vector (namely, corrected vector) obtained by subtracting (namely, by vector correction) the turning correction vector from each flow vector” is equivalent to the sum of the horizontal component of the own vehicle movement vector and the horizontal component of the subject movement vector. In the processing of detecting an approaching object, the ECU 30 can eliminate the influence (namely, influence of change of direction of vehicle 10) of the own vehicle rotation vector on each flow vector by performing identification of the approaching object based on the corrected vector.

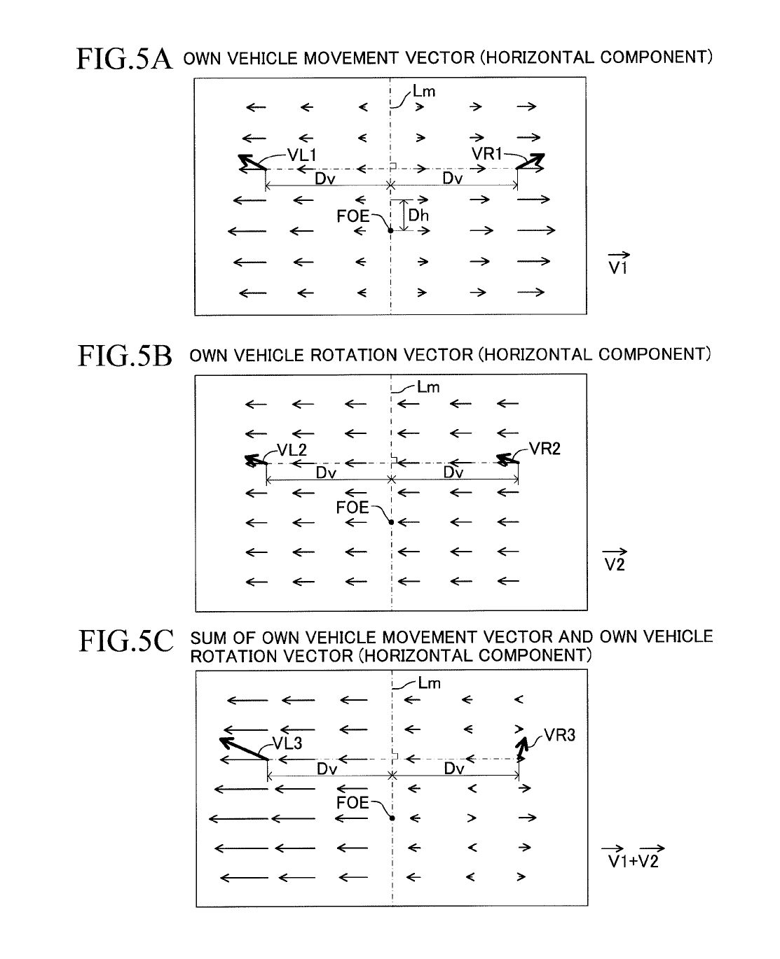

Now, a description is given of a method of estimating the turning correction vector with reference to FIG. 5A to FIG. 5C. In FIG. 5A, there is illustrated an example of horizontal components of the own vehicle movement vectors contained in the flow vectors that are acquired based on the images (first image and second image) including the front of the vehicle 10 photographed by the camera 20 for subjects that are not moving in the case in which the distance between the vehicle 10 and each of the subjects is constant. In this case, the own vehicle movement vector becomes larger as the distance between the subject in the image plane and the focus of expansion FOE becomes larger. In addition, when the magnitude of the own vehicle movement vector is the same, the horizontal component of the own vehicle movement vector becomes smaller as the perpendicular distance (for example, distance Dh in FIG. 5A) between the subject in the image plane and the focus of expansion FOE becomes longer.

In FIG. 5A, the horizontal components of a pair of own vehicle movement vectors (for example, vectors VL1 and VR1) having line-symmetric starting points with respect to the virtual center line Lm have opposite directions and the same magnitude. In other words, when the distance between the vehicle 10 and each of the subjects is constant, a mean of the horizontal components of the own vehicle movement vectors contained respectively in the pair of vectors is a zero vector as shown in Expression (1).

{horizontal component of VL1 vector (vector)+horizontal component of VR1 vector (vector)}/2=0(vector) (1)

In FIG. 5B, there is illustrated an example of horizontal components of the own vehicle rotation vectors contained in the flow vectors that are acquired based on the images (first image and second image) photographed by the camera 20 for the subjects included in the image of FIG. 5A in the case in which the vehicle 10 is turning right. The directions and the magnitudes of the own vehicle rotation vectors are equal to one another irrespective of positions of the starting points of the own vehicle rotation vectors. In other words, the mean of the horizontal components of a pair of own vehicle rotation vectors (for example, vectors VL2 and VR2) having line-symmetric starting points with respect to the virtual center line Lm equals the horizontal components of the original own vehicle rotation vectors as shown in Expression (2).

{horizontal component of VL2 vector (vector)+horizontal component of VR2 vector (vector)}/2=horizontal component of own vehicle rotation vector (vector) (2)

In FIG. 5C, sums of the vectors illustrated in FIG. 5A and FIG. 5B, namely, sums of the horizontal components of the own vehicle movement vectors and the horizontal components of the own vehicle rotation vectors are illustrated. Those are the horizontal components of flow vectors that are actually acquired. It is to be understood from Expression (1) and Expression (2) that the mean of a pair of vectors (for example, vectors VL3 and VR3) having line-symmetric starting points with respect to the virtual center line Lm illustrated in FIG. 5C is calculated to obtain the horizontal components of the own vehicle rotation vectors with the horizontal components of the own vehicle movement vectors removed.

However, each of the flow vectors calculated based on images actually photographed by the camera 20 may contain the subject movement vector as well as the own vehicle movement vector and the own vehicle rotation vector. In other words, when one or both of the pair of vectors are based on moving subjects, the mean calculated from the horizontal components of those flow vectors contains a contribution from the subject movement vector, and hence the mean is different from the horizontal components of the own vehicle rotation vectors.

In addition, because the distance between the vehicle 10 and each of the subjects is not constant but rather has a variation in actuality, respective horizontal components of the own vehicle movement vectors are not laterally symmetric to each other as illustrated in FIG. 5A. As a result, the mean of the horizontal components of the own vehicle movement vectors contained respectively in the pair of vectors may not be the zero vector.

Although this is the case, when comparing an area occupied by moving subjects (for example, other vehicles) in the left side image and the right side image with an area occupied by subjects (for example, construction) that are not moving, the area occupied by subjects that are not moving is generally larger.

In addition, when the vehicle 10 enters the T-junction in order to turn right as indicated by the solid arrow At in FIG. 2, a large proportion of subjects included in the left side image and the right side image is accounted for by road surfaces, constructions, and the like in many cases. Therefore, there are relatively many cases in which a distance (left side distance) between a “left side subject corresponding to one of the pair of vectors and included in the left side image” and the vehicle 10 and a distance (right side distance) between a “right side subject corresponding to the other of the same pair of vectors” and the vehicle 10 are approximately the same.

For example, the distance (left side distance) between a point P1 (left side subject) shown in the left side image of FIG. 4B and the vehicle 10 and the distance (right side distance) between a point P2 (right side subject) and the vehicle 10 are approximately the same. In addition, the distance (left side distance) between a point P3 (left side subject) shown in the left side image of FIG. 4B and the vehicle 10 and the distance (right side distance) between a point P4 (right side subject) and the vehicle 10 are approximately the same.

As described above, when calculating a mean of the horizontal components of the pair of vectors for various flow vectors, there may arise a case in which the mean does not equal the horizontal components of the own vehicle rotation vectors due to a “moving subject” and/or a “difference between the left side distance and the right side distance”. However, the frequency is not relatively high, and hence the mean of the horizontal components of the pair of vectors equals the horizontal components of the own vehicle rotation vectors in relatively many cases.

Therefore, the ECU 30 calculates the mean (mean vector) of the horizontal components of a pair of vectors for each flow vector, and adopts a mean vector having the highest frequency as the turning correction vector among a plurality of calculated mean vectors.

The ECU 30 carries out a vector correction to acquire corrected vectors by correcting each flow vector based on the turning correction vector. Specifically, the ECU 30 acquires the corrected vectors by subtracting the turning correction vector from the horizontal component of each flow vector.

Further, the ECU 30 identifies an approaching object based on the corrected vectors. More specifically, when a certain corrected vector has a rightward component in the left side image, the ECU 30 identifies the subject corresponding to the flow vector as an approaching object. Similarly, when a certain corrected vector has a leftward component in the right side image, the ECU 30 identifies the subject corresponding to the flow vector as an approaching object. The ECU 30 carries out this processing of identifying an approaching object for each flow vector.

(Specific Operation)

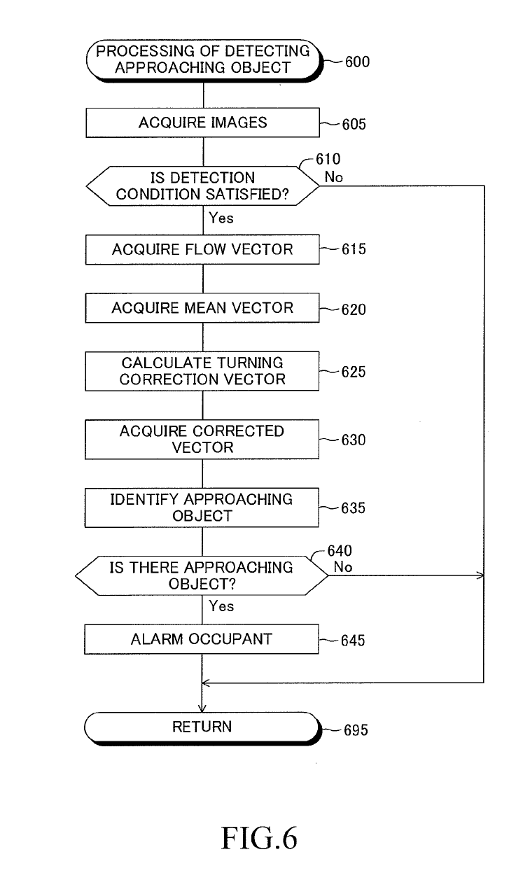

Next, a description is given of a specific operation of the ECU 30. Every time the photographing cycle Δt elapses, the CPU of the ECU 30 (hereinafter also simply referred to as “CPU”) executes a “processing routine of detecting an approaching object”, which is illustrated in a flow chart of FIG. 6.

Therefore, when an appropriate timing has come, the CPU starts the processing from Step 600 in FIG. 6 and then the processing flow proceeds to Step 605 where the CPU acquires a left side image and a right side image photographed by the camera 20. The CPU stores the acquired images in the RAM.

Next, the processing flow proceeds to Step 610 where the CPU determines whether or not a condition of detecting an approaching object is satisfied. In this example, the condition of detecting an approaching object is satisfied when the processing of detecting an approaching object is in the on-state due to the operation of the driver of the vehicle 10 and the vehicle speed Vs is equal to or lower than a speed threshold value Vth.

The speed threshold value Vth is a speed in which the frequency of non-detection is likely to increase as a result of the increased vehicle speed Vs causing the horizontal component of the own vehicle movement vector to increase, thereby cancelling out the horizontal component of the subject movement vector contained in the horizontal component of a flow vector. More specifically, as the vehicle speed Vs increases, the magnitude of the own vehicle movement vector increases. Accordingly, for example, a “magnitude of the leftward horizontal component of the own vehicle movement vector contained in the flow vector based on an approaching object in the left side image” may be larger than a “magnitude of the rightward horizontal component of the subject movement vector contained in the same flow vector”. As a result, the non-detection may occur.

When the condition of detecting an approaching object is satisfied, then the CPU determines “Yes” in Step 610 and the processing flow proceeds to Step 615 where the CPU acquires a flow vector by a block matching method based on the image (first image) acquired when the routine was previously carried out and the image (second image) acquired this time.

More specifically, the CPU divides the first image into rectangles of a predetermined size (namely, first image is considered as set of rectangles), and searches to locate positions in the second image at which the rectangles appear, respectively. As a result, flow vectors can be acquired that have the positions (moving source) of the rectangles in the first image as the starting points and have the positions (moving destination) of the rectangles in the second image as the ending points. The CPU carries out this processing for each of the rectangles forming the first image (left side image and right side image). Accordingly, a plurality of (a great number of) flow vectors are acquired.

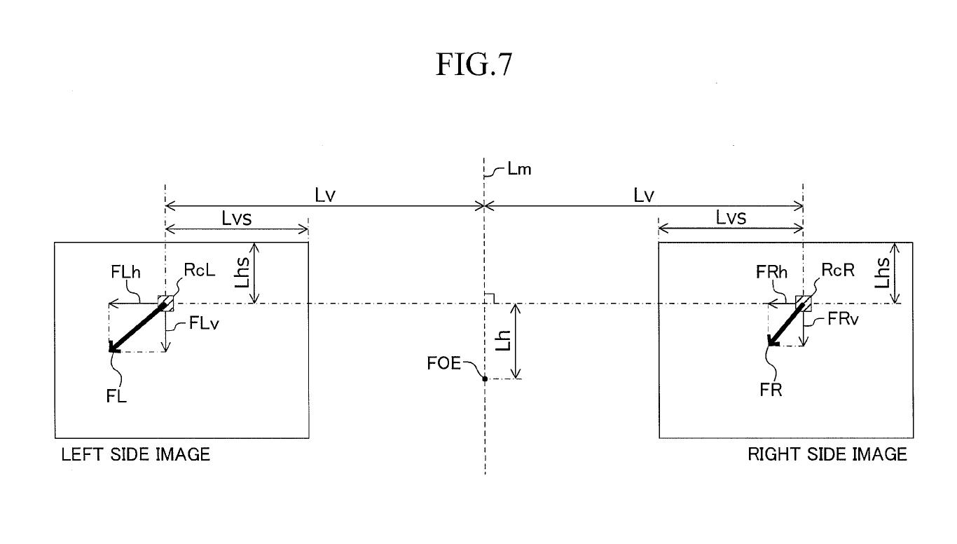

Then, the processing flow proceeds to Step 620 where the CPU calculates the mean of the horizontal components of a pair of flow vectors (namely, acquires mean vector). For example, in FIG. 7, the pair of flow vectors corresponds to a flow vector FL having, as its starting point, a rectangle RcL obtained by dividing the left side image and a flow vector FR having, as its starting point, a rectangle RcR obtained by dividing the right side image. In other words, the rectangle RcL and the rectangle RcR are line-symmetric to each other with respect to the virtual center line Lm.

In other words, in the image plane, the distance between the virtual center line Lm and the rectangle RcL and the distance between the virtual center line Lm and the rectangle RcR are each Lv, and are equal to each other. In addition, in the image plane, the perpendicular distance between the focus of expansion FOE and the rectangle RcL and the perpendicular distance between the focus of expansion FOE and the rectangle RcR are each Lh, and are equal to each other. From another point of view, the distance between a right end of the left side image and the rectangle RcL and the distance between a left end of the right side image and the rectangle RcR are each Lvs, and are equal to each other. In addition, the distance between an upper end of the left side image and the rectangle RcL and the distance between an upper end of the right side image and the rectangle RcR are each Lhs, and are equal to each other.

In order to calculate a mean vector, the CPU acquires a left side horizontal value HL, which takes a positive value when a horizontal component FLh of the flow vector FL has a rightward component or takes a negative value when the horizontal component FLh has a leftward component, and which has an absolute value equal to the magnitude of the horizontal component FLh. Similarly, the CPU acquires a right side horizontal value HR, which takes a positive value when a horizontal component FRh of the flow vector FR has a rightward component or takes a negative value when the horizontal component FRh has a leftward component, and which has an absolute value equal to the magnitude of the horizontal component FRh.

Then, the CPU calculates an average value VA (namely, VA=(HL+HR)/2) of the left side horizontal value HL and the right side horizontal value HR. The mean vector is a vector that is rightward when the average value VA has a positive value or leftward when the average value VA has a negative value, and that has a magnitude equal to the absolute value of the average value VA. When the average value VA is “0”, then the mean vector is the zero vector. The CPU carries out this processing for each flow vector. In other words, the CPU acquires a plurality of mean vectors.

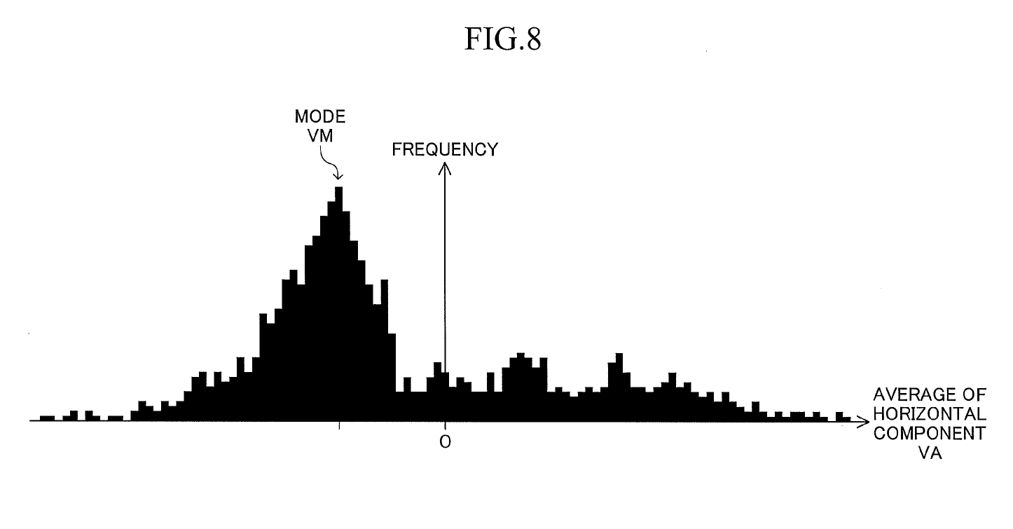

Next, the processing flow proceeds to Step 625 where the CPU calculates a turning correction vector based on the plurality of the mean vectors. More specifically, the CPU internally creates a histogram as shown in FIG. 8 for the calculated average values VA so as to acquire a value VM appearing most frequently (mode).

The CPU acquires the turning correction vector based on the mode VM. Specifically, the turning correction vector is a vector that is rightward when the mode VM has a positive value or leftward when the mode VM has a negative value, and that has a magnitude equal to the absolute value of the mode VM. When the mode VM is “0”, then the turning correction vector is the zero vector.

Next, the processing flow proceeds to Step 630 where the CPU acquires a corrected vector by subtracting (namely, by carrying out vector correction) the turning correction vector from the horizontal component of each flow vector.

Next, the processing flow proceeds to Step 635 where the CPU identifies an object approaching the vehicle 10. More specifically, when there is a corrected vector that has a rightward horizontal component in the left side image, the CPU identifies a subject corresponding to this corrected vector as an approaching object. Similarly, when there is a corrected vector that has a leftward horizontal component in the right side image, the CPU identifies a subject corresponding to this corrected vector as an approaching object.

Next, the processing flow proceeds to Step 640 where the CPU determines whether or not there is an identified approaching object. When there is a subject identified as an approaching object, then the CPU determines “Yes” in Step 640 and the processing flow proceeds to Step 645. In Step 645, the CPU changes, in the left side image and the right side image displayed on the display device 41, the color of a portion on which the subject identified as an approaching object is displayed to a color (in this example, red) different from that of the other portions. In addition, the CPU causes the speaker included in the display device 41 to output an alarm. After that, the processing flow proceeds to Step 695 where the CPU temporarily ends this routine.

On the other hand, when there is no subject identified as an approaching object, the CPU determines “No” in Step 640 and the processing flow directly proceeds to Step 695. Note that, when the condition of detecting an approaching object is not satisfied, the CPU determines “No” in Step 610 and the processing flow directly proceeds to Step 695.

As described above, this detection apparatus (camera 20 and ECU 30) includes:

an image pickup apparatus (camera 20) fixed to a vehicle body of the vehicle (10), and configured to pick up an image including a left side region and a right side region (refer to FIG. 1 and FIG. 2) outside the vehicle body;

a vector acquisition unit configured to acquire (FIG. 4A, FIG. 4B, and Step 615 in FIG. 6), based on a first image acquired by the image pickup apparatus at a first time point and a second image acquired by the image pickup apparatus at a second time point after a predetermined time period (photographing cycle Δt) from the first time point, a plurality of optical flow vectors, each representing a starting point at the first time point, a displacement amount from the first time point to the second time point, and a displacement direction from the first time point to the second time point for an arbitrary subject photographed in both of the first image and the second image;

a correction vector calculation unit configured to calculate (Step 625 in FIG. 6, and FIG. 7), as a turning correction vector, a vector based on a mean of horizontal components of a pair of vectors among the plurality of optical flow vectors, the pair of vectors having starting points that are line-symmetric to each other with respect to a virtual center line (Lm), the virtual center line passing through a point (focus of expansion FOE) indicating a straight ahead direction of the vehicle in an image plane including the left side region and the right side region, the virtual center line being orthogonal to a lateral horizontal direction of the vehicle body;

a correction unit configured to carry out (Step 630 in FIG. 6) a vector correction by correcting each of the plurality of optical flow vectors based on the turning correction vector, to thereby acquire a plurality of corrected vectors; and

an approaching object identification unit configured to identify (Step 635 in FIG. 6) an object approaching the vehicle based on the plurality of corrected vectors.

Further, in this detection apparatus:

the correction vector calculation unit calculates, as the turning correction vector, a vector (refer to FIG. 5A) equivalent to a change of a horizontal component of the each of the plurality of optical flow vectors caused by a change of direction of the vehicle from the first time point to the second time point; and

the correction unit carries out (Step 630 in FIG. 6) the vector correction by subtracting the turning correction vector from the each of the plurality of optical flow vectors.

In addition, in this detection apparatus, the correction vector calculation unit acquires (Step 620 in FIG. 6), for a plurality of the pair of vectors, a plurality of mean vectors, each being the mean of the horizontal components of each of the plurality of the pair of vectors, and adopts (Step 625 in FIG. 6, and FIG. 8) a vector having a highest frequency as the turning correction vector.

With this detection apparatus, even when the vehicle is turning, it is possible to identify an approaching object highly precisely based on flow vectors after eliminating an influence of this turning on the horizontal components of those flow vectors. In addition, with this detection apparatus, a sensor for detecting a steering angle of the vehicle 10 is unnecessary.

The approaching object detection apparatus for a vehicle according to an embodiment of the present invention is described above, but the present invention is not limited to the above-mentioned embodiment, but rather various modifications can be made thereto without departing from the object of the present invention. For example, in this embodiment, the camera 20 photographs the left side image and the right side image. However, one of two cameras arranged on the vehicle 10 may photograph the left side image while the other camera may photograph the right side image.

In addition, in this embodiment, the second image is the latest image photographed by the camera 20 and the first image is the image (namely, first image is one generation before second image) photographed by the camera 20 before the second image by the photographing cycle Δt. However, the second image may not be the latest image. Further, the first image may be an image two or more generations before the second image.

In addition, the camera 20 is fixed to the central portion of the front end of the vehicle body of the vehicle 10. However, the camera 20 may be fixed inside the vehicle interior of the vehicle 10. For example, the camera 20 may be fixed to an interior mirror (not shown) arranged inside the vehicle interior.

In other cases, the camera 20 may be fixed to a rear end of the vehicle body of the vehicle 10. In this case, the ECU 30 may identify an object approaching from the left side and the right side of the vehicle 10 when the vehicle 10 is traveling backward.

The ECU 30 determines that the condition of detecting an approaching object is satisfied when the processing of detecting an approaching object is in the on-state due to the operation of the driver of the vehicle 10 and the vehicle speed Vs is equal to or lower than the speed threshold value Vth. However, the ECU 30 may determine that the condition of detecting an approaching object is satisfied when the processing of detecting an approaching object is in the on-state irrespective of the vehicle speed Vs.

In addition, the ECU 30 acquires the optical flow vector by the block matching method in Step 615 of FIG. 6. The ECU 30 may acquire the optical flow vector by another method (for example, gradient method).

In addition, the ECU 30 adopts the mode as the turning correction value in Step 625 of FIG. 6. However, the ECU 30 may adopt an average value or a median as the turning correction value instead of the mode.

What is claimed is:

1. An approaching object detection apparatus for a vehicle, comprising:
an image pickup apparatus fixed to a vehicle body of the vehicle, and configured to pick up an image including a left side region and a right side region outside the vehicle body;
a vector acquisition unit configured to acquire, based on a first image acquired by the image pickup apparatus at a first time point and a second image acquired by the image pickup apparatus at a second time point after a predetermined time period from the first time point, a plurality of optical flow vectors, each representing a starting point at the first time point, a displacement amount from the first time point to the second time point, and a displacement direction from the first time point to the second time point for an arbitrary subject photographed in both of the first image and the second image;
a correction vector calculation unit configured to calculate, as a turning correction vector, a vector that is based on a mean of horizontal components of a pair of vectors among the plurality of optical flow vectors, the pair of vectors having starting points that are line-symmetric to each other with respect to a virtual center line, the virtual center line passing through a point indicating a straight ahead direction of the vehicle in an image plane including the left side region and the right side region, the virtual center line being orthogonal to a lateral horizontal direction of the vehicle body;
a correction unit configured to carry out a vector correction by correcting each of the plurality of optical flow vectors based on the turning correction vector, to thereby acquire a plurality of corrected vectors; and
an approaching object identification unit configured to identify an object approaching the vehicle based on the plurality of corrected vectors.

2. An approaching object detection apparatus according to claim 1,
wherein the correction vector calculation unit calculates, as the turning correction vector, a vector equivalent to a change of a horizontal component of the each of the plurality of optical flow vectors caused by a change of direction of the vehicle from the first time point to the second time point, and
wherein the correction unit carries out the vector correction by subtracting the turning correction vector from the each of the plurality of optical flow vectors.

3. An approaching object detection apparatus according to claim 2, wherein the correction vector calculation unit acquires, for a plurality of the pair of vectors, a plurality of mean vectors, each being the mean of the horizontal components of each of the plurality of the pair of vectors, and adopts a vector having a highest frequency as the turning correction vector.

4. An approaching object detection apparatus for a vehicle, comprising:
an image pickup apparatus fixed to a vehicle body of the vehicle, and configured to pick up an image including a left side region and a right side region outside the vehicle body;
a vector acquisition unit configured to acquire, based on a first image acquired by the image pickup apparatus at a first time point and a second image acquired by the image pickup apparatus at a second time point after a predetermined time period from the first time point, a plurality of optical flow vectors, each representing a starting point at the first time point, a displacement amount from the first time point to the second time point, and a displacement direction from the first time point to the second time point for an arbitrary subject photographed in both of the first image and the second image;
a correction vector calculation unit configured to calculate, as a turning correction vector, a vector that is based on a mean of horizontal components of a pair of vectors among the plurality of optical flow vectors, the pair of vectors having starting points that are line-symmetric to each other with respect to a virtual center line, the virtual center line passing through a focus of expansion in an image plane including the left side region and the right side region, the virtual center line being orthogonal to a lateral horizontal direction of the vehicle body;
a correction unit configured to carry out a vector correction by correcting each of the plurality of optical flow vectors based on the turning correction vector, to thereby acquire a plurality of corrected vectors; and
an approaching object identification unit configured to identify an object approaching the vehicle based on the plurality of corrected vectors.

5. A method of detecting an approaching object for a vehicle, comprising:
picking up, by an image pickup apparatus fixed to a vehicle body of the vehicle, an image including a left side region and a right side region outside the vehicle body;
acquiring, based on a first image acquired by the image pickup apparatus at a first time point and a second image acquired by the image pickup apparatus at a second time point after a predetermined time period from the first time point, a plurality of optical flow vectors, each representing a starting point at the first time point, a displacement amount from the first time point to the second time point, and a displacement direction from the first time point to the second time point for an arbitrary subject photographed in both of the first image and the second image;
calculating, as a turning correction vector, a vector that is based on a mean of horizontal components of a pair of vectors among the plurality of optical flow vectors, the pair of vectors having starting points that are line-symmetric to each other with respect to a virtual center line, the virtual center line passing through a focus of expansion in an image plane including the left side region and the right side region, the virtual center line being orthogonal to a lateral horizontal direction of the vehicle body;
carrying out a vector correction by correcting each of the plurality of optical flow vectors based on the turning correction vector, to thereby acquire a plurality of corrected vectors; and
identifying an object approaching the vehicle based on the plurality of corrected vectors.
